(19) United States
(12) Patent Application Publication
(10) Pub. No.: US 2013/0238776 A1
(43) Pub. Date: Sep. 12, 2013

(54) DEVICE MANAGEMENT APPARATUS, DEVICE MANAGEMENT SYSTEM, AND COMPUTER PROGRAM PRODUCT

(71) Applicant: Tsutomu KINOMOTO, Kanagawa (JP)

(72) Inventor: Tsutomu KINOMOTO, Kanagawa (JP)

(21) Appl. No.: 13/785,179

(22) Filed: Mar. 5, 2013

(30) Foreign Application Priority Data
Mar. 7, 2012 (JP) 2012-050348

(51) Int. Cl. H04L 12/24

(52) U.S. Cl. CPC H04L 41/046
USPC 709/223

(57) ABSTRACT

According to an embodiment, provided is a device management apparatus that manages a device. The device management apparatus includes: a device information acquiring unit that acquires device information that is information of a device; an additional component information acquiring unit that acquires additional component information that is information of an additional component added to the device; a generating unit that generates additional component identification information identifying the additional component; and a linking unit that links the device information and the additional component information based on the additional component identification information.

### CROSS-REFERENCE TO RELATED APPLICATIONS

The present application claims priority to and incorporates by reference the entire contents of Japanese Patent Application No. 2012-050348 filed in Japan on Mar. 7, 2012.

### BACKGROUND OF THE INVENTION

1. Field of the Invention

The present invention relates to a device management apparatus, a device management system, and a computer program product.

2. Description of the Related Art

Conventionally, a device management apparatus has been known that manages devices through a network. Also a technique has been known that identifies a peripheral by generating an identification number of the peripheral when a peripheral not having an identification number is to be connected to a peripheral server (Japanese Patent Application Laid-open No. 2011-014036, for example).

Recently, a device preliminarily equipped with various option components has been introduced; or some option component has been additionally introduced to an unequipped device if necessary. In such manners, there are diverse operation forms of devices in client environments.

For example, many option components are not exclusive for a particular device, but can be also used in other devices having the performance (a certain throughput defined by a provider, and the scalability to various interfaces, for example) equivalent to that of the particular device. The recent situation, where a great change in environment is kept continuing, it is supposed that use of an option component currently used in one device is to be more used in another device; and relations between option components and a device will become more complicated.

If the usage manner (or, usage pattern) of option components and a device changes, sometimes there will occur inconvenience in asset management. However, with respect to device operation, the entire device operates without inconvenience as long as it is used in an environment in which the option components and the device are compatible. Therefore, the device management system now operating can not recognize change of usage manner of a device as problems in asset management.

There is a need to provide a device management apparatus, a device management system, and a computer program product capable of linking a device with an additional component added to the device.

### SUMMARY OF THE INVENTION

It is an object of the present invention to at least partially solve the problems in the conventional technology.

According to an embodiment, provided is a device management apparatus that manages a device. The device management apparatus includes: a device information acquiring unit that acquires device information that is information of a device; an additional component information acquiring unit that acquires additional component information that is information of an additional component added to the device; a generating unit that generates additional component identification information identifying the additional component; and a linking unit that links the device information and the additional component information based on the additional component identification information.

According to another embodiment, provided is a device management system that includes: a device management apparatus that manages a device; and an external device. The device management apparatus includes a device information acquiring unit that acquires device information that is information of the device, the device information including device identification information that identifies the device, an additional component information acquiring unit that acquires additional component information that is information of an additional component added to the device, a generating unit that generates additional component identification information that identifies the additional component, a linking unit that links the device information and the additional component information based on the additional component identification information, and a notification unit that notifies the external device of at least one of the device identification information and the additional component identification information. The external device links the device information, the additional component information, and information managed by the external device based on at least one of identification information notified by the device management apparatus.

According to still another embodiment, provided is a computer program product that includes a non-transitory computer-usable medium having computer-readable program codes embodied in the medium for a device management apparatus that manages a device, the program codes when executed, causing a computer to execute: acquiring device information that is information of the device; acquiring additional component information that is information of an additional component added to the device; generating additional component identification information that identifies the additional component; and linking the device information and the additional component information based on the additional component identification information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an example of a device management system of a first embodiment;

FIG. 2 is a block diagram illustrating an example of a configuration of a device of the first embodiment;

FIG. 3 is a block diagram illustrating an example of a configuration of a device management apparatus of the first embodiment;

FIG. 4 is a diagram illustrating an example of device information stored in a device information storage unit of the first embodiment;

FIG. 5 is a diagram illustrating an example of additional component information that is stored in an additional component information storage unit of the first embodiment before linkage;

FIG. 6 is a diagram illustrating an example of additional component information that is stored in the additional component information storage unit of the first embodiment after linkage;

FIG. 7 is a block diagram illustrating an example of a configuration of an asset management apparatus of the first embodiment;

FIG. 8 is a diagram illustrating an example of asset information stored in an asset information storage unit of the first embodiment;

FIG. 9 is a sequence diagram illustrating an example of the operation of the device management system of the first embodiment;

FIG. 10 is a block diagram illustrating an example of a configuration of a device management apparatus in a device management system of a second embodiment;

FIG. 11 is a sequence diagram illustrating an example of the operation of the device management system of the second embodiment; and

FIG. 12 is a block diagram illustrating an example of a hardware configuration of the device management apparatus and the asset management apparatus in the first and second embodiments.

### DETAILED DESCRIPTION OF THE PREFERRED EMBODIMENTS

In the following, embodiments of a device management apparatus, a device management system and a computer program product are described in detail with reference to the accompanying drawings.

### First Embodiment

First, a configuration of a device management system of the first embodiment is described.

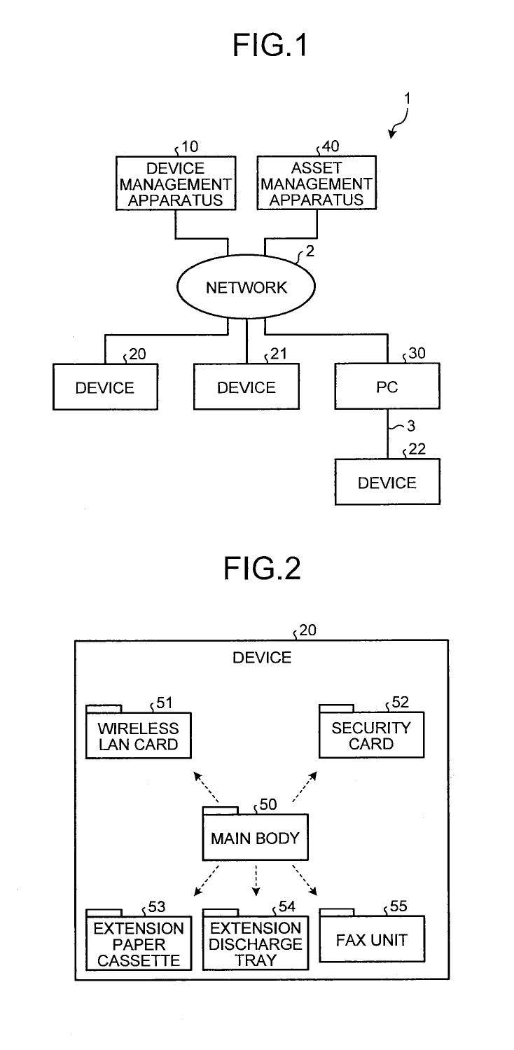

FIG. 1 is a block diagram illustrating an example of a configuration of a device management system 1 of the first embodiment. As illustrated in FIG. 1, the device management system 1 has a device management apparatus 10, devices 20 to 22, a personal computer (PC) 30, and an asset management apparatus 40.

The device management apparatus 10, the devices 20 and 21, the PC 30, and the asset management apparatus 40 are connected through a network 2. The device 22 and the PC 30 are connected to each other through a communication interface 3. The network 2 can be constituted by Internet, or a local area network (LAN), for example. The communication interface 3 can be constituted by a universal serial bus (USB) cable, for example.

The device management apparatus 10 manages devices to be managed such as the devices 20 to 22 and the PC 30, and can be constituted by a PC in which a device management program is installed. FIG. 1 exemplifies the devices 20 to 22 and the PC 30 as devices to be managed by the device management apparatus 10. However, devices to be managed are not limited thereto.

The devices 20 and 21 may be any devices that can be connected to the network 2. The device 22 may be any device that can be connected to the communication interface 3. The devices 20 to 22 are exemplified by image forming apparatuses such as a printing device, a copying machine, a multifunction peripheral (MFP), a scanner, and a facsimile; and various electronic devices such as a projector, a camera, an air conditioner, a refrigerator, a fluorescent light, a vending machine, and a hand-held terminal, for example. The MFP has at least two functions among a copying function, a printing function, a scanner function, and a facsimile function. The first embodiment exemplifies a case where the devices 20 to 22 are MFPs.

In the following description, a device to be managed that is connected to the network 2 may be referred to as a network device; and a device to be managed that is not connected to the network 2 may be referred to as a local device.

The asset management apparatus 40 manages asset information of fixed assets such as the devices 20 to 22 and the PC 30, and can be constituted by a PC in which an asset management program is installed.

FIG. 2 is a block diagram illustrating an example of a configuration of the device 20 of the first embodiment. As illustrated in FIG. 2, the device 20 has a main body 50, a wireless LAN card 51, a security card 52, an extension paper cassette 53, an extension discharge tray 54, and a fax unit 55.

The main body 50 is a standard component that is normally provided in the device 20. The main body 50 may include a network interface card (NIC), a standard paper cassette, a standard discharge tray, and the like.

The wireless LAN card 51, the security card 52, the extension paper cassette 53, the extension discharge tray 54, and the fax unit 55 are additional components (that may be referred to as option, hereinafter) that are added to the device 20, and can be also added to a device other than the device 20.

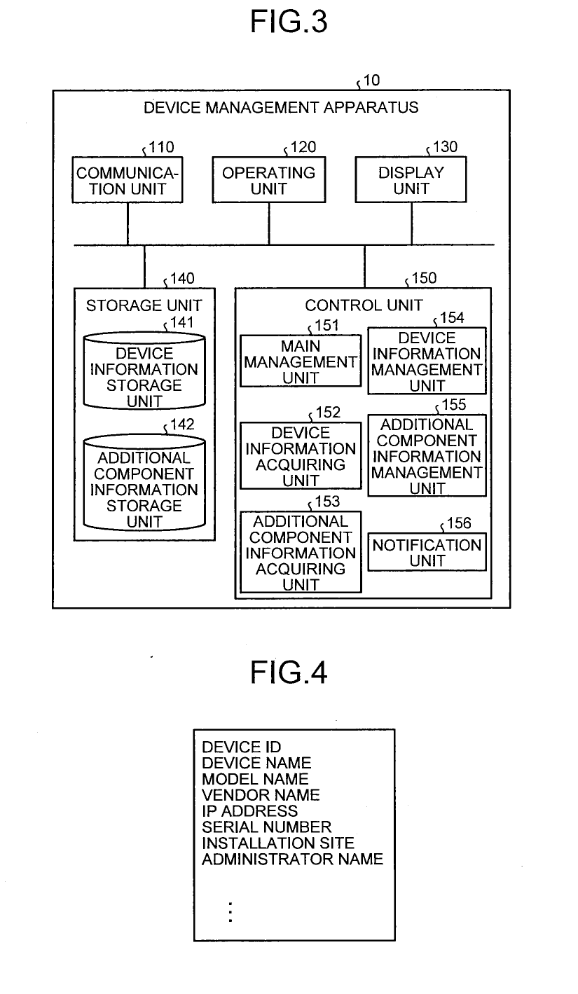

FIG. 3 is a block diagram illustrating an example of a configuration of the device management apparatus 10 of the first embodiment. As illustrated in FIG. 3, the device management apparatus 10 has a communication unit 110, an operating unit 120, a display unit 130, a storage unit 140, and a control unit 150.

The communication unit 110 communicates with external devices such as the devices 20 and 21, the PC 30, and the asset management apparatus 40 through the network 2, and can be constituted by the NIC, and the like.

The operating unit 120 allows input of various kinds of operation, and can be constituted by an input device such as a keyboard, a mouse, a touch pad, and a touch panel.

The display unit 130 displays various screens, and can be constituted by a display device such as a liquid crystal display and a touch panel display.

The storage unit 140 stores therein various computer programs such as a device management program executed in the device management apparatus 10, data used for various kinds of processing performed in the device management apparatus 10 and the like. The storage unit 140 can be constituted by at least any one of storage devices such as a hard disk drive (HDD), a solid state drive (SSD), a memory card, an optical disk, a read only memory (ROM), and a random access memory (RAM). Such storage devices can store therein computer programs, data, and the like magnetically, optically, or electrically.

The storage unit 140 has a device information storage unit 141, and an additional component information storage unit 142. The details of the device information storage unit 141 and the additional component information storage unit 142 are described later.

The control unit 150 controls each unit of the device management apparatus 10, and can be constituted by a control device such as a central processing unit (CPU).

The control unit 150 has a main management unit 151, a device information acquiring unit 152, an additional component information acquiring unit 153, a device information management unit 154, an additional component information management unit 155, and a notification unit 156. Here, the control unit 150 activates (executes) a device management program stored in the storage unit 140; so as to realize as software the main management unit 151, the device information acquiring unit 152, the additional component information acquiring unit 153, the device information management unit 154, the additional component information management unit 155, and the notification unit 156.

The main management unit 151 controls each unit of the control unit 150.

The device information acquiring unit 152 acquires device information that is information of devices such as the devices 20 to 22 and the PC 30 to be managed. The device information may be any information regarding a device main body, and may include a device identification data (ID) identifying a device (which is an example of device identification information), a device name, a model name, a vendor name, an Internet Protocol (IP) address, a serial number, an installation site, and an administrator name, for example.

The additional component information acquiring unit 153 acquires additional component information that is information of an additional component added to a device to be managed such as the devices 20 to 22 and the PC 30. The additional component information may be any information of an option, and may include an option name, a model name, a vendor name, a serial number, an installation site, and an administrator name, for example.

In the first embodiment, the device information acquiring unit 152 and the additional component information acquiring unit 153 perform communication using a protocol such as a Simple Network Management Protocol (SNMP) with a device to be managed so as to acquire device information and additional component information of the device to be managed.

However, how to acquire device information and additional component information is not limited to a method involving an acquisition request sent to a device to be managed, and may be one in which a device to be managed itself notifies the device management apparatus 10 of the device information and the additional component information thereof.

Regarding a local device such as the device 22, the device information acquiring unit 152 and the additional component information acquiring unit 153 requests a network device such as the PC 30 that is connected to the local device to acquire the device information and the additional component information of the local device, and acquires the device information and the additional component information of the local device that are obtained by the network device.

When the additional component information acquiring unit 153 fails to acquire additional component information, it displays, on the display unit 130, an error message and an input screen of additional component information. Thus, the additional component information acquiring unit 153 acquires additional component information input by a user through the operating unit 120.

The device information management unit 154 manages device information on the device information storage unit 141. To be more specific, the device information management unit 154 stores device information acquired by the device information acquiring unit 152 in the device information storage unit 141; acquires device information from the device information storage unit 141; and updates device information stored in the device information storage unit 141.

FIG. 4 is a diagram illustrating an example of device information stored in the device information storage unit 141 of the first embodiment. In the example illustrated in FIG. 4, the device information includes a device ID, a device name, a model name, a vendor name, an IP address, a serial number, an installation site, an administrator name, and the like.

The additional component information management unit 155 (one example of a generating unit and a linking unit) manages additional component information on the additional component information storage unit 142. To be more specific, the additional component information management unit 155 stores additional component information acquired by the additional component information acquiring unit 153 in the additional component information storage unit 142; acquires additional component information from the additional component information storage unit 142; and updates additional component information stored in the additional component information storage unit 142.

The additional component information management unit 155 generates an option ID identifying an additional component (one example of additional component identification information). To be more specific, the additional component information management unit 155 generates an option ID based on unique information included in the additional component information. For example, the additional component information management unit 155 sets a serial number or a Media Access Control (MAC) address included in the additional component information as the option ID.

The additional component information management unit 155 links the device information and the additional component information based on the generated option ID. To be more specific, the additional component information management unit 155 adds the option ID and the device ID to the additional component information. Thus, the device information and the additional component information are linked to each other.

FIG. 5 is a diagram illustrating an example of additional component information stored in the additional component information storage unit 142 of the first embodiment, and illustrates additional component information before linkage with the device information. The additional component information illustrated in FIG. 5 is acquired by the additional component information acquiring unit 153, and is stored in the additional component information storage unit 142 by the additional component information management unit 155. Here, the additional component information includes an option name, a model name, a vendor name, a serial number, an installation site, an administrator name and the like.

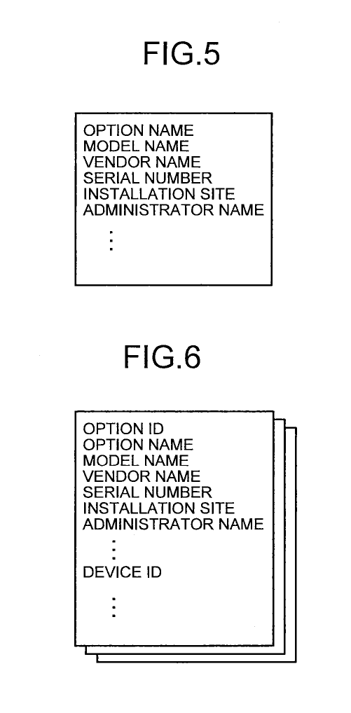

FIG. 6 is a diagram illustrating an example of additional component information stored in the additional component information storage unit 142 of the first embodiment, and illustrates additional component information after linkage with the device information. The additional component information illustrated in FIG. 6 is obtained by the additional component information management unit 155 linking the additional component information illustrated in FIG. 5 with the device information illustrated in FIG. 4. Here, the additional component information includes an option ID, an option name, a model name, a vendor name, a serial number, an installation site, an administrator name, a device ID, and the like. Note that the option ID and the device ID are not included in the additional component information acquired by the additional component information acquiring unit 153, but are added to the additional component information by the additional component information management unit 155.

The notification unit 156 notifies the asset management apparatus 40 (one example of an external device) of at least one of the device ID and the option ID. For example, the notification unit 156 notifies the asset management apparatus 40 of the device ID.

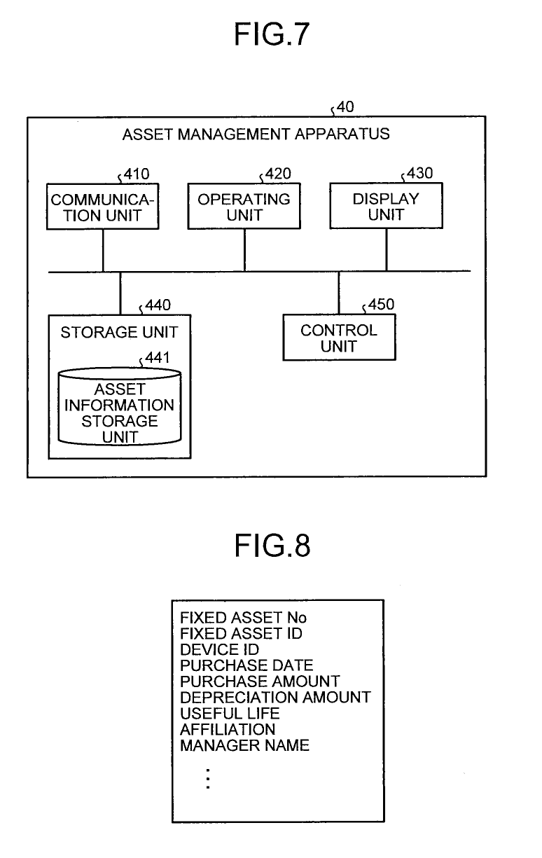

FIG. 7 is a block diagram illustrating an example of a configuration of the asset management apparatus 40 of the first embodiment. As illustrated in FIG. 7, the asset management apparatus 40 has a communication unit 410, an operating unit 420, a display unit 430, a storage unit 440, and a control unit 450.

The communication unit 410 communicates with an external device such as the device management apparatus 10, and includes an NIC, and the like.

The operating unit 420 allows input of various kinds of operation, and can be constituted by an input device such as a keyboard, a mouse, a touch pad, and a touch panel.

The display unit 430 displays various screens, and can be constituted by a display device such as a liquid crystal display and a touch panel display.

The storage unit 440 stores therein various computer programs such as an asset management program executed in the asset management apparatus 40, data used for various kinds of processing performed in the asset management apparatus 40, and the like. The storage unit 440 can be constituted by at least any one of storage devices such as an HDD, an SSD, a memory card, an optical disk, a ROM, and a RAM. Such storage devices can store therein computer programs, data, and the like magnetically, optically, or electrically.

The storage unit 440 has an asset information storage unit 441. The asset information storage unit 441 stores therein asset information that is information of fixed assets including devices to be managed by the device management apparatus 10 such as the devices 20 to 22 and the PC 30.

The control unit 450 controls each unit of the asset management apparatus 40, and can be constituted by a control device such as a CPU. The control unit 450 links, based on at least one of the device ID and the option ID notified by the device management apparatus 10, the device information and additional component information of the device indicated by the device ID, and the asset information. For example, the control unit 450 adds the device ID notified by the device management apparatus 10 to the asset information of the device. Thus, it is possible to associate (link) the device information and additional component information managed by the device management apparatus 10 with the asset information managed by the asset management apparatus 40.

FIG. 8 is a diagram illustrating an example of asset information stored in the asset information storage unit 441 of the first embodiment. In the example illustrated in FIG. 8, the asset information includes a fixed asset number, a fixed asset ID, a device ID, a purchase date, a purchase amount, a depreciation amount, a useful life, an affiliation, a manager name, and the like. The device ID is added to the asset information by the control unit 450.

Next, the operation of the device management system of the first embodiment is described.

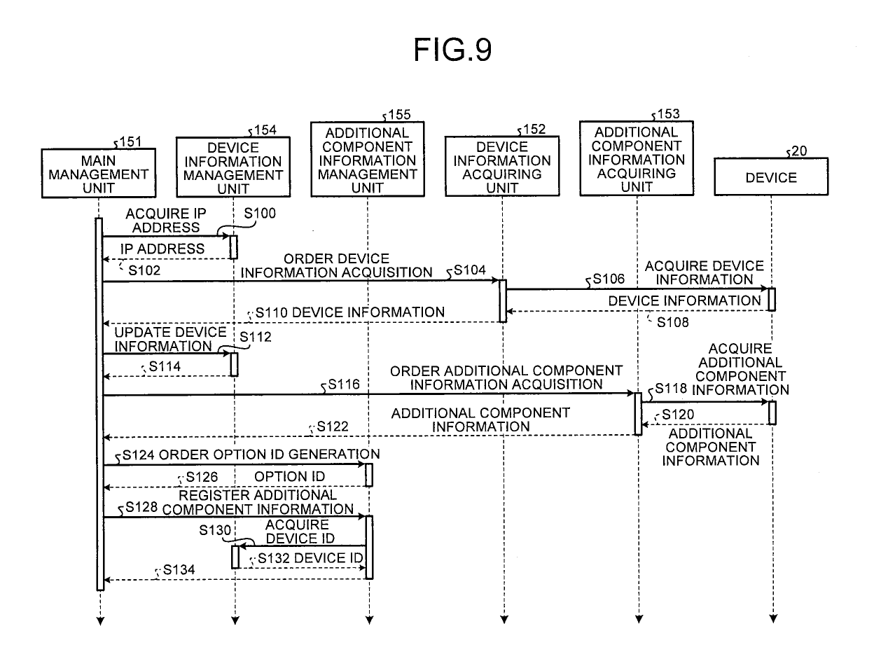

FIG. 9 is a sequence diagram illustrating an example of the operation of the device management system 1 of the first embodiment. FIG. 9 exemplifies the operation in a case where the fax unit 55 is added as a new option to the device 20. However, the invention is not limited thereto.

First, when given time is measured by a timer (not illustrated) of the device management apparatus 10 or when an instruction is transmitted by a user through the operating unit 120, the main management unit 151 requests the device information management unit 154 to acquire an IP address of the device 20 (Step S100).

The device information management unit 154 acquires the IP address from the device information of the device 20 stored in the device information storage unit 141, and sends it back to the main management unit 151 (Step S102).

Next, the main management unit 151 notifies the device information acquiring unit 152 of the IP address of the device 20, and orders the device information acquiring unit 152 to acquire the device information of the device 20 (Step S104).

The device information acquiring unit 152 establishes communication with the device 20 using the IP address of the device 20, and requests the device 20 to acquire the device information (Step S106).

The device 20 acquires the device information registered in the device itself, and transmits it to the device management apparatus 10 (device information acquiring unit 152) (Step S108).

The device information acquiring unit 152 sends the device information of the device 20 back to the main management unit 151 (Step S110).

The main management unit 151 notifies the device information management unit 154 of the device information of the device 20, and requests the device information management unit 154 to update the device information of the device 20 (Step S112).

The device information management unit 154 updates the device information of the device 20 stored in the device information storage unit 141 with the notified device information of the device 20, and notifies the main management unit 151 of update completion (Step S114).

Subsequently, the main management unit 151 notifies the additional component information acquiring unit 153 of the IP address of the device 20, and orders the additional component information acquiring unit 153 to acquire the additional component information of the device 20 (Step S116).

The additional component information acquiring unit 153 establishes communication with the device 20 using the IP address of the device 20, and requests the device 20 to acquire the additional component information (Step S118).

The device 20 acquires the additional component information from the fax unit 55 added to the device itself, and transmits that information to the device management apparatus 10 (additional component information acquiring unit 153) (Step S120).

The additional component information acquiring unit 153 sends the additional component information of the device 20 back to the main management unit 151 (Step S122).

Then, the main management unit 151 notifies the additional component information management unit 155 of the additional component information of the device 20, and orders the additional component information management unit 155 to generate an option ID of the additional component information of the device 20 (Step S124).

The additional component information management unit 155 sets a serial number included in the additional component information of the device 20 as the option ID, and sends it back to the main management unit 151 (Step S126).

Subsequently, the main management unit 151 notifies the additional component information management unit 155 of the additional component information and the option ID, and requests the additional component information management unit 155 to register the additional component information of the device 20 (Step S128).

Then, the additional component information management unit 155 requests the device information management unit 154 to acquire the device ID of the device 20 (Step S130).

The device information management unit 154 acquires the device ID from the device information of the device 20 stored in the device information storage unit 141, and sends it back to the additional component information management unit 155 (Step S132).

Subsequently, the additional component information management unit 155 adds the option ID and the device ID to the additional component information, and registers the additional component information to which the option ID and the device ID are added in the additional component information storage unit 142. Then, the additional component information management unit 155 notifies the main management unit 151 of registration completion (Step S134).

In the example illustrated in FIG. 9, the device information of the device 20 is already stored in the device information storage unit 141, and the notification unit 156 has already notified the asset management apparatus 40 of the device ID. When the notification unit 156 has not notified the asset management apparatus 40 of the device ID, the notification unit 156 notifies the asset management apparatus 40 of the device ID thereafter.

As described above, in the first embodiment, the option ID is generated for an additional component; and the device information and the additional component information are linked to each other based on the generated option ID. Therefore, it is possible to manage the device and the additional component added to the device in a linking manner.

Moreover, in the device management system of the first embodiment, the device information and the additional component information are linked to each other based on the option ID, and thus, when the device management system notifies the asset management system of the device ID, the device information and the asset information can be linked to each other based on the device ID. As a result, it is possible to link the device information, the additional component information, and the asset information one to another. This makes it possible, in the asset management system, to manage not only the device but also the additional components (options) added to the device as fixed assets.

### Second Embodiment

The second embodiment describes an example in which an option ID is generated by another manner. The following description mainly focuses on the difference from the first embodiment. Thus, the components having the same function as in the first embodiment are represented with the same reference or symbol as in the first embodiment, and the description thereof is omitted.

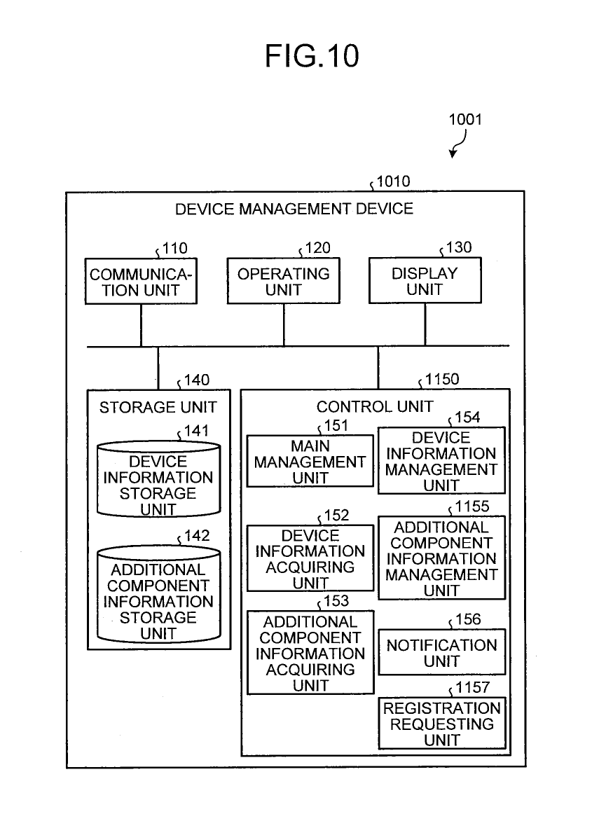

FIG. 10 is a block diagram illustrating an example of a configuration of a device management apparatus 1010 in a device management system 1001 of the second embodiment. As illustrated in FIG. 10, the device management apparatus 1010 is different from the first embodiment in an additional component information management unit 1155 and a registration requesting unit 1157 provided in a control unit 1150.

In the first embodiment, the additional component information management unit 155 generates an option ID based on unique information included in additional component information. However, additional component information may not include unique information such as a serial number and a MAC address. In such a case, the additional component information management unit 1155 of the second embodiment generates an option ID based on non-unique information included in the additional component information and unique information included in the device information. For example, the additional component information management unit 1155 combines a serial number or a MAC address included in the device information with a model name included in the additional component information; and sets it as the option ID. Thus, even if the additional component information does not include unique information, it is possible to generate a unique option ID.

When the additional component information management unit 1155 generates new additional component identification information that is different from the one already added to the additional component information, it further adds the new additional component identification information to the additional component identification information.

When the additional component information management unit 1155 generates an option ID based on non-unique information included in the additional component information and unique information included in the device information, the registration requesting unit 1157 requests a device from which the additional component information is acquired to register the option ID. Thus, the option ID is registered in a nonvolatile storage unit (in a nonvolatile semiconductor memory, for example) of the device from which the additional component information is acquired.

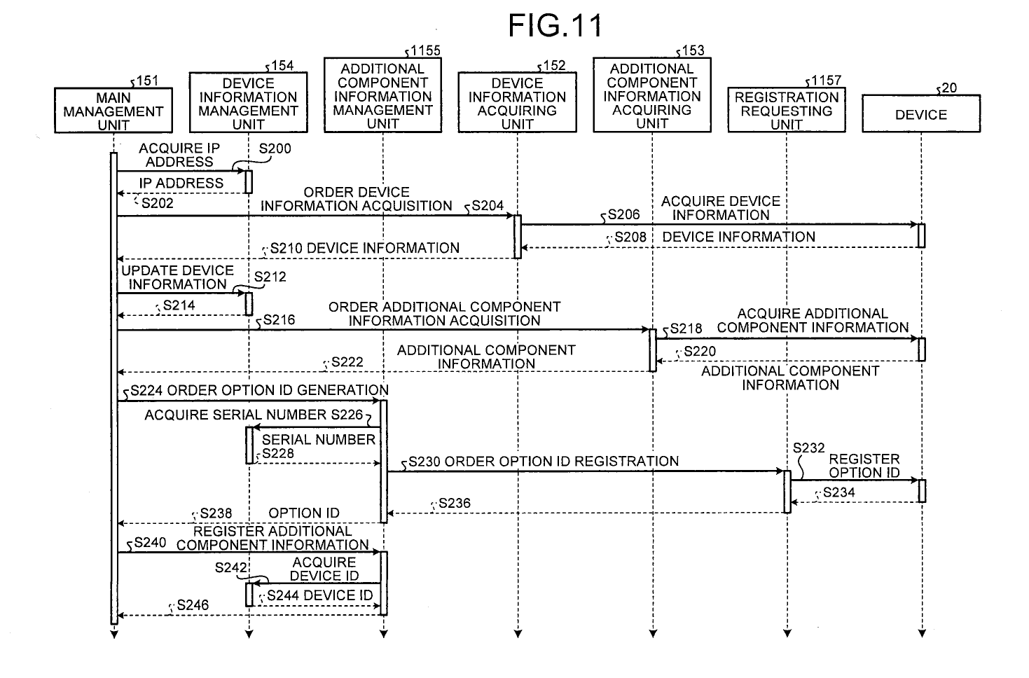

FIG. 11 is a sequence diagram illustrating an example of the operation of the device management system 1001 of the second embodiment. FIG. 11 exemplifies an operation in a case where the extension discharge tray 54 is added as a new option to the device 20. However, the invention is not limited thereto.

First, the processing at Steps S200 to S224 is the same as the processing at Steps S100 to S124 in the sequence diagram of FIG. 9. However, the additional component information acquired by the device 20 at Step S220 is of the extension discharge tray 54.

Subsequently, the additional component information management unit 1155 requests the device information management unit 154 to acquire the serial number of the device 20 (Step S226).

The device information management unit 154 acquires the serial number from the device information of the device 20 stored in the device information storage unit 141, and sends it back to the additional component information management unit 1155 (Step S228).

The additional component information management unit 1155 combines the serial number of the device 20 with the model name included in the additional component information of the device 20, and sets it as the option ID. Then, the additional component information management unit 1155 notifies the registration requesting unit 1157 of the option ID, and orders the registration requesting unit 1157 to register the option ID in the device 20 (extension discharge tray 54) (Step S230).

The registration requesting unit 1157 transmits the option ID to the device 20, and requests the device 20 to register the option ID in the extension discharge tray 54 (Step S232).

The device 20 registers the option ID in the extension discharge tray 54, and transmits the registration completion to the device management apparatus 1010 (registration requesting unit 1157) (Step S234).

The registration requesting unit 1157 notifies the additional component information management unit 1155 of completion of option ID registration into the extension discharge tray 54 (Step S236).

The following Steps S238 to S246 are the same as the processing at Steps S126 to S134 in the sequence diagram of FIG. 9.

As described above, in the second embodiment, it is possible to generate a unique option ID even if the additional component information does not include any unique information. This prevents overlap of an option ID, thus making it possible to certainly identify additional component information based on an option ID.

In the second embodiment, even if the additional component information does not include unique information, that is, an additional component (option) does not include unique information, an option ID unique to the additional component is registered therein. Therefore, it is possible to easily search the additional component (option) using the option ID.

In the second embodiment, a new option ID that is different from an existing option ID is generated when an additional component (option) is added to a different device. Here, the new option ID is added to the additional component information while the old option ID remains therein, which still enables a history search using the old option ID.

Hardware Configuration

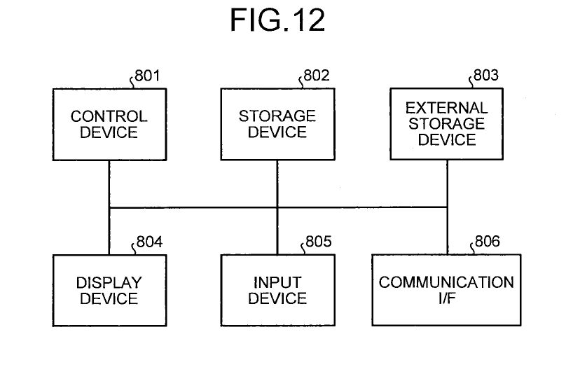

FIG. 12 is a block diagram illustrating an example of a hardware configuration of the device management apparatus and the asset management apparatus of the first and second embodiments. As illustrated in FIG. 12, the device management apparatus and the asset management apparatus of the embodiments have a control device 801 such as a CPU, a storage device 802 such as a ROM and a RAM, an external storage device 803 such as an HDD and an SSD, a display device 804 such as a display, an input device 805 such as a mouse and a keyboard, and a communication interface (I/F) 806 such as an NIC. The device management apparatus and the asset management apparatus can be constituted with a hardware configuration using a general computer.

A computer program executed in the device management apparatus and the asset management apparatus of the embodiments is recorded, as a file whose format is installable or executable, in a computer readable recording medium such as a compact disk read only memory (CD-ROM), a compact disk recordable (CD-R), a memory card, a digital versatile disk (DVD), and a flexible disk (FD), and is provided.

The program executed in the device management apparatus and the asset management apparatus of the embodiments may be stored in a computer connected to a network such as Internet, and then be provided by download thereof through the network. Alternatively, the program executed in the device management apparatus and the asset management apparatus of the embodiments may be provided or distributed through a network such as Internet. The program executed in the device management apparatus and the asset management apparatus of the embodiments may be preliminarily embedded in a ROM, and the like, and be provided.

The program executed in the device management apparatus and the asset management apparatus of the embodiments is of a module configuration for achieving the above-described units on a computer. As actual hardware, the control device 801 reads out the program from the external storage device 803 onto the storage device 802, and executes it, so that the units are achieved on the computer.

Modifications

The invention is not limited to the above embodiments, and various kinds of modifications are possible.

For example, in the embodiments described above, the device ID and the option ID are added to the additional component information so as to link the device information and the additional component information. However, the option ID may be added to the device information and the additional component information so as to link the device information and the additional component information.

The embodiments exemplify the asset management apparatus as an external device linked to the device management apparatus. However, an external device linked to the device management apparatus is not limited thereto. The embodiments exemplify the asset information as information linked to the device information and the additional component information. However, information linked to the device information and the additional component information is not limited thereto.

The embodiments exemplify a case where the device management apparatus 10 stores the device information and the additional component information. However, the device information and the additional component information may be stored externally. For example, a device information database storing therein device information and an additional component information database storing therein additional component information may be provided externally (on cloud computing, for example).

In the embodiment, it makes possible to link a device and an additional component that is added to the device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A device management apparatus that manages a device, comprising:
a device information acquiring unit that acquires device information that is information of a device;
an additional component information acquiring unit that acquires additional component information that is information of an additional component added to the device;
a generating unit that generates additional component identification information identifying the additional component; and
a linking unit that links the device information and the additional component information based on the additional component identification information.

2. The device management apparatus according to claim 1, wherein
the device information includes device identification information identifying the device, and
the linking unit adds the additional component identification information and the device identification information to the additional component information.

3. The device management apparatus according to claim 2, further comprising a notification unit that notifies an external device of at least one of the device identification information and the additional component identification information.

4. The device management apparatus according to of claim 1, wherein
the generating unit generates the additional component identification information based on unique information included in the additional component information.

5. The device management apparatus according to claim 1, wherein
the generating unit generates the additional component identification information based on non-unique information included in the additional component information and unique information included in the device information.

6. The device management apparatus according to claim 5, further comprising
a registration requesting unit that requests the device to register therein the additional component identification information.

7. The device management apparatus according to claim 5, wherein
the linking unit further adds additional component identification information newly generated by the generating unit to the additional component information.

8. The device management apparatus according to claim 1, further comprising:
a device information storage unit that stores therein the device information; and
an additional component information storage unit that stores therein the additional component information.

9. A device management system, comprising:
a device management apparatus that manages a device; and
an external device, wherein
the device management apparatus comprises
a device information acquiring unit that acquires device information that is information of the device,
the device information including device identification information that identifies the device,
an additional component information acquiring unit that acquires additional component information that is information of an additional component added to the device,
a generating unit that generates additional component identification information that identifies the additional component,
a linking unit that links the device information and the additional component information based on the additional component identification information, and
a notification unit that notifies the external device of at least one of the device identification information and the additional component identification information; and
the external device links the device information, the additional component information, and information managed by the external device based on at least one of identification information notified by the device management apparatus.

10. A computer program product comprising a non-transitory computer-usable medium having computer-readable program codes embodied in the medium for a device management apparatus that manages a device, the program codes when executed, causing a computer to execute:
acquiring device information that is information of the device;
acquiring additional component information that is information of an additional component added to the device;
generating additional component identification information that identifies the additional component; and
linking the device information and the additional component information based on the additional component identification information.
